(19) United States
(12) Patent Application Publication
(10) Pub. No.: US 2018/0163741 A1
(43) Pub. Date: Jun. 14, 2018

(54) Impeller for a Centrifugal Pump, and Centrifugal Pump

(71) Applicant: GEA Tuchenhagen GmbH, Büchen (DE)

(72) Inventors: Markus Pawlik, Büchen (DE); Ulli Zimmer, Rüsselsheim (DE)

(21) Appl. No.: 15/579,035

(22) PCT Filed: Jun. 2, 2016
(86) PCT No.: PCT/EP2016/062534

§ 371 Date: Dec. 1, 2017

(30) Foreign Application Priority Data
Jun. 3, 2015 (DE) 10 2015 007 171.8

(51) Int. Cl. F04D 29/22; F04D 7/04; F04D 29/24

(52) U.S. Cl. CPC F04D 29/2288; F04D 7/045; F05B 2240/30; F04D 29/2266; F05B 2250/15; F04D 29/245

(57) ABSTRACT

An impeller for a centrifugal pump that includes a housing, an inlet, an outlet, and a chamber in the housing and in fluidic contact with the inlet and the outlet is described. The impeller is rotatably accommodated in the chamber, and a gap is between a rear side of the impeller and a housing wall. To improve the compatibility with media forming deposits, the impeller has at least one scraper that is integrally bonded at a first position and a second position to the impeller. The first position and the second position are at a distance from each other, and a cleanable clearance is in this space between the scraper and the rear side of the impeller.

### TECHNICAL FIELD

The disclosure relates to an impeller for a centrifugal pump and to a centrifugal pump.

### BACKGROUND

Centrifugal pumps are known and have been used for many years successfully in the processing industry. The processing industry comprises, in particular, the beverage industry, food industry, pharmaceuticals and biochemistry.

The basic design of such centrifugal pumps possesses a housing that is provided with an inlet, an outlet, and a chamber that is provided in the housing and is in fluidic connection with the inlet and outlet. An impeller is rotatably accommodated in the chamber.

In the patent literature, many aspects of centrifugal pumps have already been considered, including the design of this impeller.

It is for example known from NL 275 238 A to provide blades on the rear side of the impeller that serve to regulate the pressure of the medium on the rear side of the impeller. No additional effect is discussed and appears not to exist.

Applications for centrifugal pumps in the aforementioned fields of use are known in which media with fibrous and solid components are pumped.

One type of centrifugal pump that can be used in such applications is designed so that fibers and solid components can be comminuted. U.S. Pat. No. 7,118,327 B2 proposes such a centrifugal pump in which structures projecting on the rear side of the impeller are provided that mesh with structures provided on the housing.

WO 2011/139223 A1 takes up this concept and proposes a slightly different solution. The rear side of the impeller in this case is provided with a plurality of projections. This added radial extension of the projections is at an interval of +/−10%, +/−25% up to +/−40% of the radius of the impeller. This solution functions without structures meshing.

### BRIEF SUMMARY

Described herein are a centrifugal pump and an impeller for a centrifugal pump that, by way of a simple design, yield greater compatibility with media that can form deposits.

An impeller for a centrifugal pump has a housing, an inlet, an outlet, and a chamber that is provided in the housing and is in fluidic connection to the inlet and outlet. The impeller is rotatably accommodated in the chamber, and a gap is provided between a rear side of the impeller and a housing wall. This impeller is characterized in that it has at least one scraper integrally bonded with the impeller at a first location and a second location, wherein the first position and the second position are at a distance from each other, and a cleanable clearance is created in this distance between the scraper and rear side. When the impeller rotates, this scraper eliminates deposits that have collected for example when the impeller is at rest. The safe level is reached once enough deposits have been eliminated to achieve unbraked rotation of the impeller. The integral bond with the scraper makes it possible to economically equip a standard impeller for using the centrifugal pump with solid-forming media. Instead of a low quantity of special parts, the use of standard parts produced in large quantities is possible as a basis. By connecting the scraper and impeller at two locations, it is unnecessary to create extensive integral bonds, for example by welding. This simplifies production and prevents stress and distortion of the impeller from the input of heat in thermal methods. The clearance between the scraper and impeller is dimensioned between the connection sites such that cleaning fluid that is introduced at application-typical pressure into the centrifugal pump reliably eliminates media residue.

The centrifugal pump possesses a housing on which an inlet and an outlet are arranged. Within the housing, a chamber is provided in fluidic connection with the inlet and outlet in which an impeller is rotatably accommodated. A gap is formed between a rear side of the impeller and a housing wall. Deposits from the pumped medium within this gap are reduced to a harmless level in that the impeller has at least one scraper integrally bonded with the impeller at a first location and a second location, wherein the first position and the second position are at a distance from each other, and a cleanable clearance is created in this space between the scraper and rear side. When the impeller rotates, this scraper eliminates deposits that have collected for example when the impeller is at rest. The harmless level is reached when enough of the deposits are eliminated to achieve rotation of the impeller without braking contact with deposits. The integral bond with the scraper makes it possible to economically equip a standard impeller for using the centrifugal pump with solid-forming media. Instead of a low quantity of special parts, the use of standard parts produced in large quantities as a foundation is possible. By connecting the scraper and impeller at two locations, is unnecessary to create extensive integral bonds, for example by welding. This simplifies production and prevents stress and distortion of the impeller from heat input in thermal methods. The clearance between the scraper and impeller is dimensioned between the connection sites such that cleaning fluid introduced at application-typical pressure into the centrifugal pump reliably eliminates media residue. Advantageously, the clearance is dimensioned such that the cleanability requirements formulated in the guidelines of the “European Hygienic Engineering & Design Group”, the “EHEDG Guidelines”, are met. The requirements are listed in “A method for the assessment of in-place cleanability of food processing equipment” in the third edition of ISBN 0 907503 17 9.

In a development, beyond the scraper, the compatibility of the centrifugal pump with solid-forming material can be enhanced by an additional measure. The centrifugal pump possesses an inlet, an outlet, a housing that is formed by a floor and a cover, a chamber that is provided in the housing and is in fluidic connection with the inlet and outlet, an impeller that is rotatably accommodated in the chamber provided in the housing, and a gap provided between a rear side of the impeller and a housing wall. The media compatibility is enhanced in that a spacing element is arranged between the cover and the floor and is connected to the cover and the floor, and an axial width of the gap is at least as large as an axial thickness of the spacing element. The axial thickness of the spacing element is dimensioned such that the occurrence of a deposit on the housing wall does not immediately lead to an increase in the gap and hence blockage of the impeller. An existing centrifugal pump can be retrofitted by subsequently inserting a spacing element and possibly exchanging other components, for example an elongated shaft, and rendered more compatible for solid-forming media. Only a few additional easy-to-produce components are needed in production; consequently this solution is very economical.

The invention, its developments and the portrayal of the advantages will be elucidated with reference to the following figures.

### BRIEF DESCRIPTION OF THE DRAWINGS

FIG. 1 shows a side view of a centrifugal pump.

FIG. 2 shows a section of a centrifugal pump with an impeller in a first design.

FIG. 3 shows a detailed view of the housing with a spacing element between components of the housing.

FIG. 4 shows a view of an impeller in a second design.

FIG. 5 shows a view of an impeller in a third design.

FIG. 6 shows a view of an impeller in a fourth design.

FIG. 7 shows a view of an impeller in a fifth design.

FIG. 8 shows a view of an impeller in a sixth design.

FIG. 9 shows a view of an impeller in a seventh design.

FIG. 10 shows a view of an impeller in an eighth design.

FIG. 11 shows a view of an impeller in a ninth design.

FIG. 12 shows a view of an impeller in a tenth design.

### DETAILED DESCRIPTION

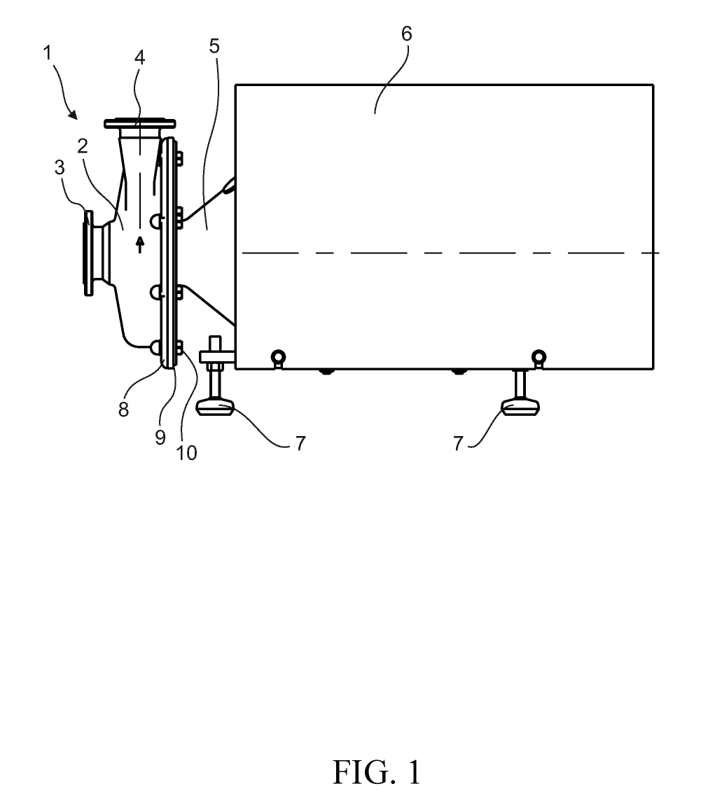

FIG. 1 shows a centrifugal pump 1 in a lateral plan view. The centrifugal pump 1 comprises a housing 2 that is provided with an inlet 3 and an outlet 4. The inlet 3 and the outlet 4 are designed to be connectable to a fluid conducting arrangement such as a pipeline system. The housing 2 of the centrifugal pump 1 is borne by a lantern 5, wherein the lantern 5 establishes a connection to a motor arrangement. The motor arrangement, generally comprising an electric motor, is located below a cover 6 and rests on feet 7. The housing 2 is built in several parts, wherein the parts are releasably connected to each other to enable easy servicing such as cleaning. To enable the releasable connection, a cover flange 8 and a floor flange 9 are provided that are releasably connected by screws 10.

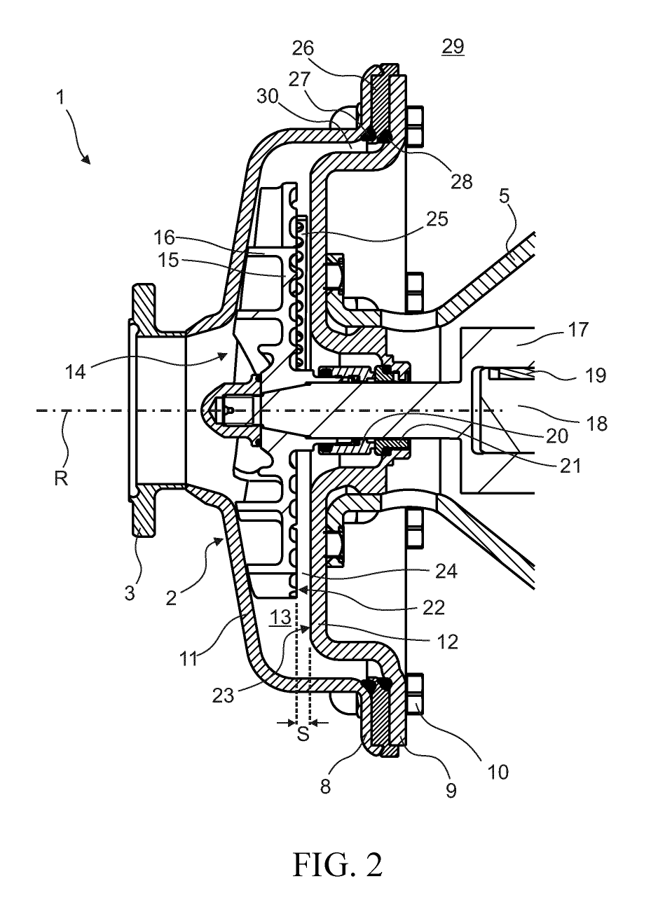

The centrifugal pump 1 is shown in FIG. 2 in a sectional view. The housing 2 comprises a cover 11 with the cover flange 8 and a floor 12 with the floor flange 9. The cover flange 8 and the floor flange 9 are arranged so as to be indirectly and/or indirectly contacting, and are connected to each other by suitable securing means, with screws 10 in the depicted example. The cover 11 and the floor 12 border a chamber 13 in which the impeller 14 is rotatably accommodated. The impeller 14 can be designed in a semi-open structure in that a blade 16 or plurality of blades 16 are arranged on a disc-shaped main body 15 on a side of the disc-shaped main body 15 facing the inlet 3.

The impeller 14 is rotatably supported by a pump shaft 17 about a rotary axis R in an overhung arrangement that, for its part, is rotatably fastened to a motor shaft 18. With a key 19 that is arranged to engage in the pump shaft 17 and the motor shaft 18, non-rotation of the shafts relative to each other can be effectuated. When transitioning into the chamber 13, the pump shaft 17 penetrates a seal arrangement that is designed as a sliding ring seal and for example comprises a sliding ring 20 rotatably attached to the pump shaft 17, and a sliding ring 21 arranged in the housing. This seal arrangement can also be designed as a purged sliding ring seal, for example according to the design in DE 203 16 570 U1.

Between the housing wall 23 that is formed on the floor 12 and a rear side 22 of the impeller 14 that faces the housing wall 23, a gap 24 is formed with a gap width S. In applications of the centrifugal pump 1 in which solid-forming media enter the chamber 13, solids can deposit on the housing wall 23 and/or the rear side 22. The running of the impeller 14 is impaired or rendered impossible when these deposits have filled up the gap width S. A scraper 25 or a plurality of such scrapers 25 is therefore arranged on the rear side 22 and is designed such that solid deposits on the housing wall 23 are reduced by scraping until the gap 24 is free enough to permit free rotation of the impeller 14.

Alternatively or in addition to the scraper 25, a spacing element 26 can be provided between the cover 11 and the floor 12, advantageously between the cover flange 8 and the floor flange 9. The centrifugal pump 1 can be equipped therewith for applications in which solid formation in the gap 24 is anticipated or observed. The gap width S is increased by this spacing element 26 beyond the standard extent. A first seal 27 is provided between the spacing element 26 and the cover 11. A second seal 28 is located between the floor 12 and the spacing element 26. The first seal 27 and the second seal 28 establish a reliable seal of the chamber 13 against the surroundings 29 of the centrifugal pump 1. Advantageously, the seals 27 and 28 are designed and held according to hygienic standards such as DIN 11864.

The chamber 13 can have a peripheral channel 30 that extends in an axial direction as a cylindrical projection in the direction of the motor arrangement. It can be designed as a spiral channel in the peripheral direction. The seals 27 and 28 as well as the spacing element 26 can be arranged as a spatial limit to this peripheral channel 30.

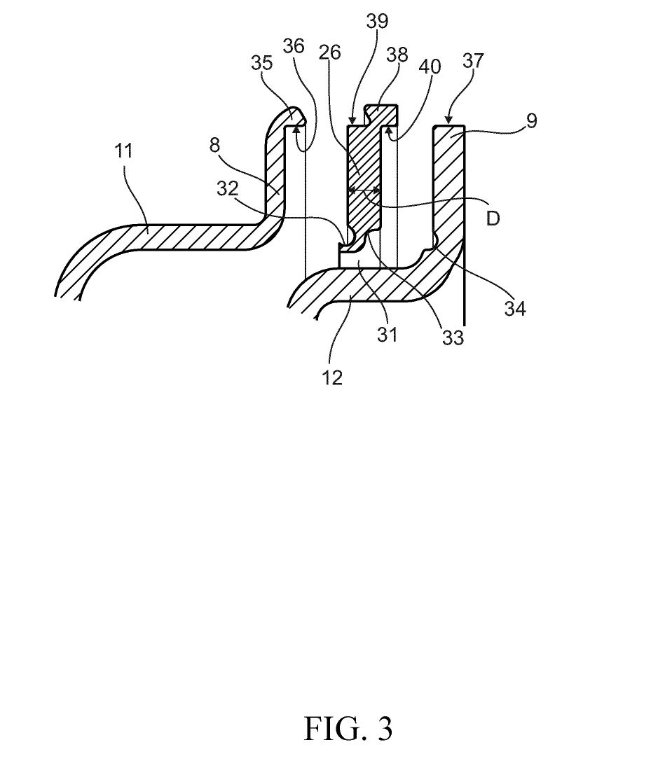

FIG. 3 shows an exploded representation of the housing 2 with the spacing element 26. The spacing element 26 is shaped like a ring with a central ring opening 31. A section of the floor 12 extends through this ring opening 31.

On a side of the spacing element 26 facing the cover flange 8, a first groove 32 is provided that surrounds the ring opening 31. This first groove 32 serves to accommodate the first seal 27. A second groove 33 that also surrounds the ring opening 31 is formed on a side of the spacing element 26 facing the floor flange 9. The second groove 33 interacts with a third groove 34 that is formed in the floor flange 9 in that the second and third grooves 33 and 34 accommodate the second seal 28 together. The third groove 34 is designed so that it accommodates a seal corresponding to hygienic requirements when the cover flange 8 and the floor flange 9 are directly connected to each other without the spacing element 26.

The cover flange 8 possesses a collar 35 that extends in an axial direction toward the floor 12. On its side radially to the interior, the collar 35 has a first inner surface 36. The first inner surface 36 is configured to interact with an edge surface 37 of the floor flange 9. If the centrifugal pump 1 is assembled without a spacing element 26, the collar 35 encloses the floor flange 9, and the first inner surface 36 and edge surface 37 cause the cover 11 and the floor 12 to be centered relative to each other.

The spacing element 26 possesses an edge section 38 that is shaped as a ring axially offset in the direction of the floor flange 9. Due to this offset, an outer surface 39 is formed on the spacing element 26. Together with the first inner surface 36, this outer surface 39 causes a radial alignment, in particular a substantial centering of the spacing element 26 relative to the cover flange 8. On the side of the spacing element 26 facing the floor flange 9, the edge section 38 extends beyond the spacing element 26 in an axial direction and has a second inner surface 40. Together with the edge surface 37, the second inner surface 40 causes a substantially concentric alignment of the spacing element 26 and the floor flange 9 relative to each other.

The gap width S of the gap 24 in an axial direction is at least as large as an axial thickness D of the spacing element 26. Advantageously, the cover 11, the floor 12, and spacing element 26 are designed so that the gap width S is increased by the thickness D by installing the spacing element 26. This is achieved by the arrangement according to FIG. 3 in which the annular spacing element can be mounted with its thickness D between the cover flange 8 and the floor flange 9.

The scraper 25 can have features according to one or more of the following design types and can be combined with one feature or several features of the design of the rear side 22 of the impeller 14.

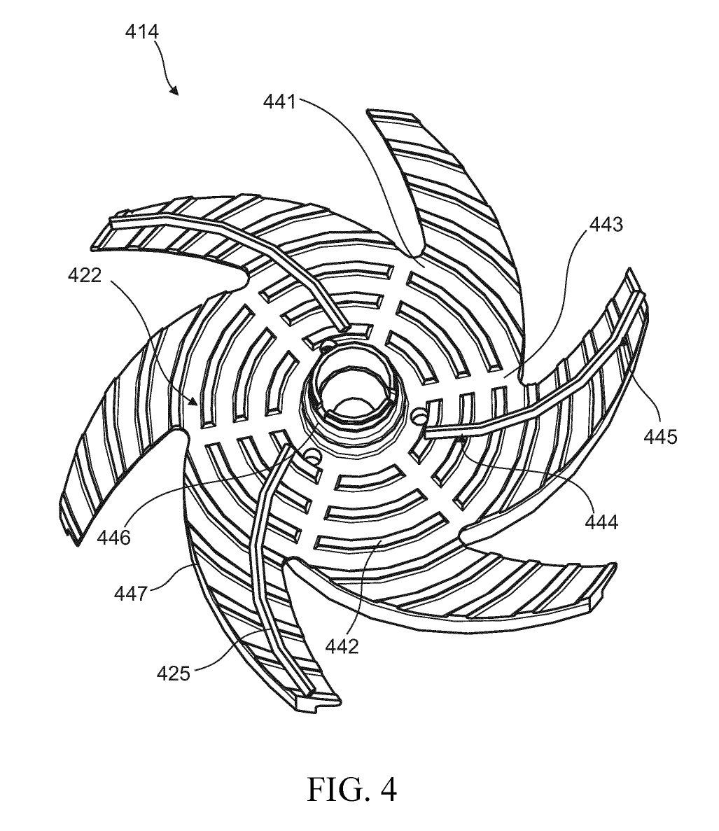

FIG. 4 shows a view of a rear side 422 of a peripheral impeller 414. This is structured with elevations and recesses, for example by machining steps during production. The structure comprises peripheral grooves 441 arranged in a circle that alternate with circular peripheral bars 442 in a radial direction. The peripheral bars 442 are interrupted by radial grooves 443 so that the peripheral bars 442 only extend partially peripherally. The radial grooves 443 run in a straight line proceeding from a midpoint of the impeller 414, but can also be designed curved as shown in the following developments. At least one scraper 425 is attached in an integral manner with the peripheral bars 442. If the impeller 414 and the scraper 425 are produced from stainless steel, the integral bond is preferably brought about by welding. The integral bond with the scraper 425 is created at at least one first and one second location 444 and 445 of the peripheral bars 442 projecting furthermost from the impeller 414. The scraper 425 bridges the peripheral grooves 441. This bridge simultaneously establishes a clearance between the scraper 425 and the impeller 414. This is designed with dimensions to satisfy the application-specific hygiene requirements. This is for example satisfied when the walls bordering the clearance abut each other at a right angle or a larger angle, and the maximum distance between the scraper 425 and the impeller 414 is a few millimeters. The distance is advantageously dimensioned so that the specifications according to the aforementioned document are satisfied with ISBN 0 907503 17 9. The scraper 425 extends radially to the outside in a radial extension from a region close to a hub 446 of the impeller 414, and runs toward a tooth 447 of the impeller 414 bent in a peripheral direction. The bend in the tooth 447 yields a bend in the scraper 425. The scraper 425 entirely covers the radius of the impeller 414.

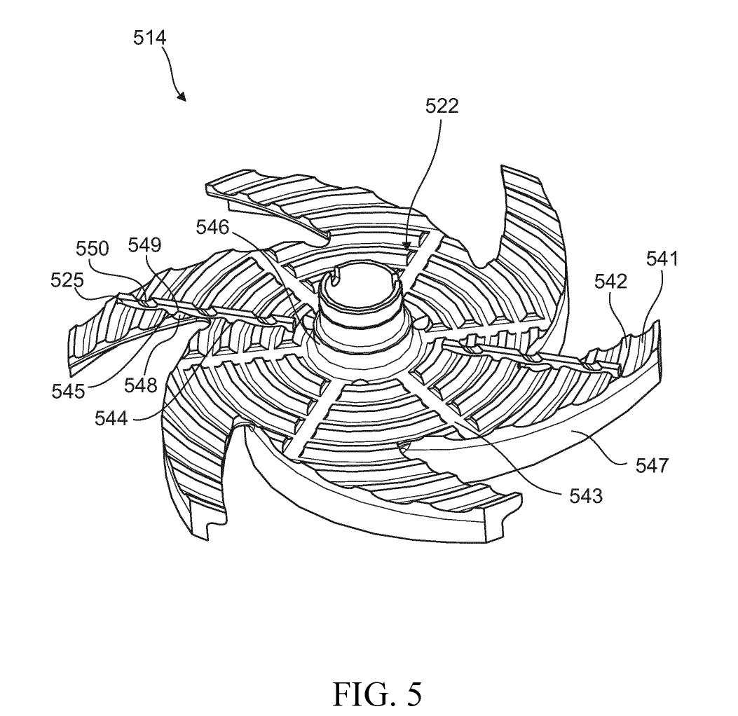

FIG. 5 shows a slightly altered form of an impeller 514. Here as well, the rear side 522 also has a structure in the form of circular peripheral grooves 541 and peripheral bars 542, which are interrupted in their circular path by radial grooves 543 extending substantially in a radial direction. The radial grooves 543 run in a straight line and can proceed from a center of the hub 546. The scraper 525 runs in a straight line proceeding from the hub 546 and extends to one of the teeth 547. For this reason and due to the straight path, there is only one extension of the scraper 525 in the radial direction of the impeller 514 that does not reach the full radius. In particular the inner part of the impeller 514 is covered. The scraper 525 has bottom recesses 549 on its side facing the impeller 514. Top recesses 550 are arranged on its side facing away from the impeller 514. The top recesses 550 improve the effect of the scraper 525; deposits in the gap 24 are removed more efficiently. The bottom recesses 549 enlarge the clearance 548 between the scraper 525 and the impeller 514 so that they can be cleaned more easily, and so that the centrifugal pump 1 satisfies hygienic requirements more readily. The scraper 525 is integrally bonded with the crests of the peripheral bars 542 at at least one first location 544 and at least one second location 545.

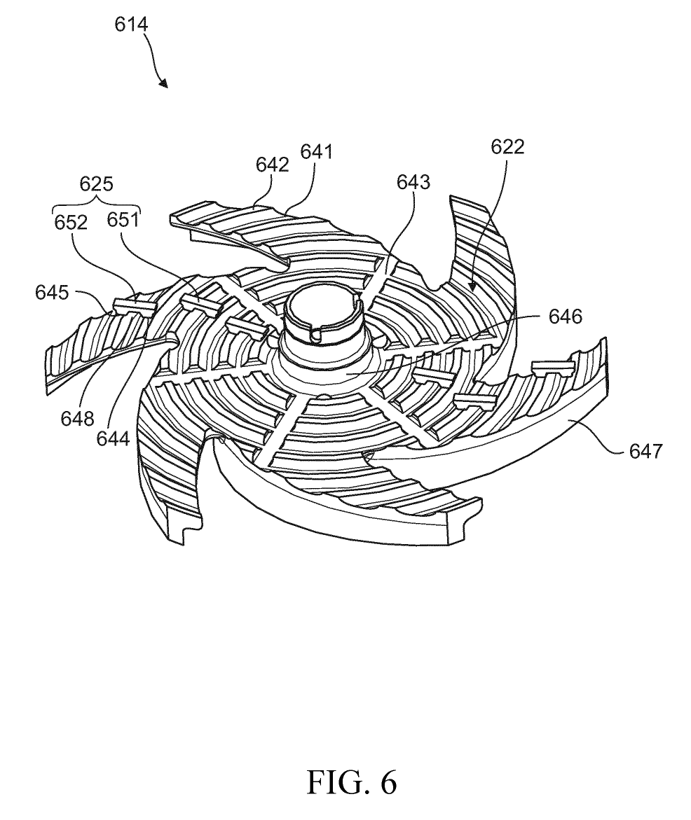

The embodiment according to FIG. 6 shows an impeller 614 that has peripheral grooves 641 and peripheral bars 642 on its rear side 622 that also alternate in a radial direction and are circular. These are interrupted by radial grooves 643 extending in a radial direction. The scraper 625 in this embodiment is designed segmented and comprises at least one first segment 651 and at least one second segment 652. Each of the segments 651 and 652 is connected in each case at a first location 644 and second location 645 with two, preferably adjacent, peripheral grooves 641 while forming a clearance 648. The segments 651 and 652 are offset relative to each other in a radial direction in order to increase the total radial coverage by the scraper 625, and to increase the scraping effect to eliminate deposits. Segments can be located close to the hub 646 and be arranged on a tooth 647, or a plurality of teeth 647. The total radial coverage by the segments 651 and 652 can be more than 60% to achieve a positive effect with economic production.

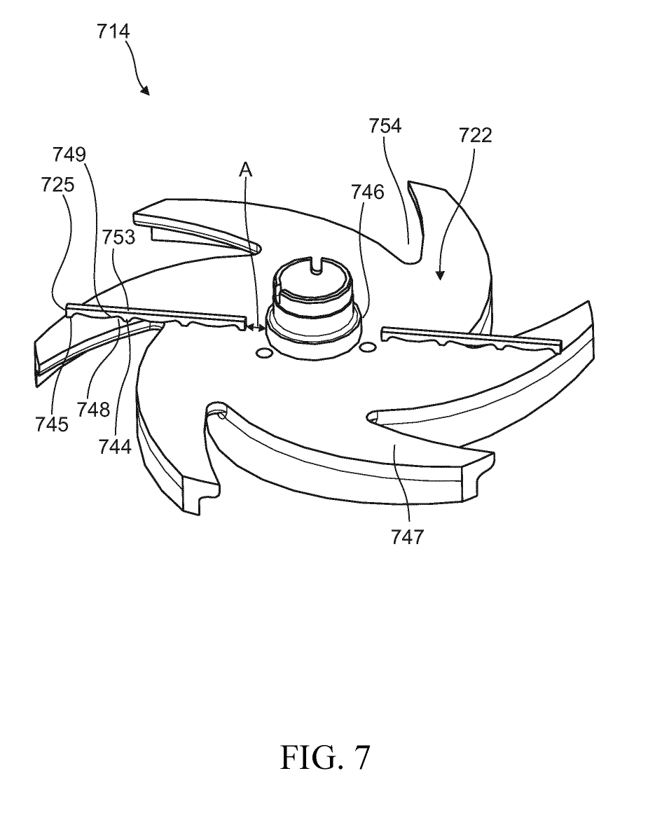

In the embodiment according to FIG. 7, the impeller 714 possesses a smooth rear side 722 where a structure like in the previously described examples is omitted. The scraper 725, of which a plurality can be distributed along the perimeter to achieve an improved effect and to simplify the balancing of the impeller 714, extends straight in a radial direction. Its top edge 753 that faces away from the rear side 722 is smooth without elevations or recesses. On the side opposite the top edge 753 in an axial direction, the scraper 725 possesses at least one bottom recess 749 by means of which a clearance 748 is created between the rear side 722 and the scraper 725. This clearance 748 extends between a first location 744 and a second location 745 at which an integral bond is created between the rear side 722 and the scraper 725. The radial extension of the scraper 725 starts at a distance A to the hub 746 and extends up to one of the teeth 747, wherein more than two-thirds of the radius of the impeller 714 can be covered in order to achieve a positive cleaning effect. In this context, the scraper 725 can bridge a space 754 between two adjacent teeth 747.

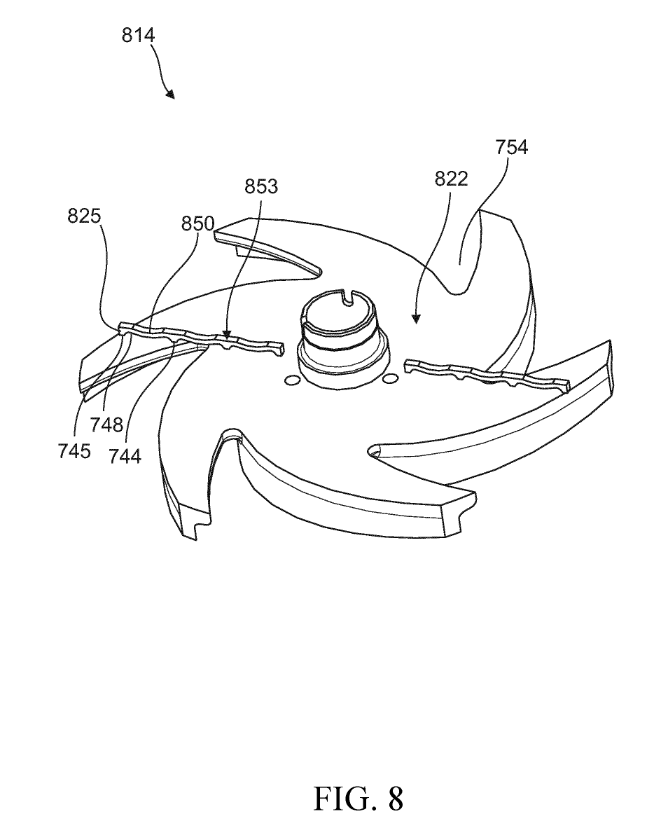

The embodiment depicted in FIG. 8 largely corresponds to the embodiment explained with reference to FIG. 7. A scraper 825 is integrally bonded with the smooth rear side 822 of the impeller 814. In contrast to the embodiment according to FIG. 7, the top edge 853 of the scraper 825 is structured by top recesses 850, wavy for example. This produces effective cleaning power.

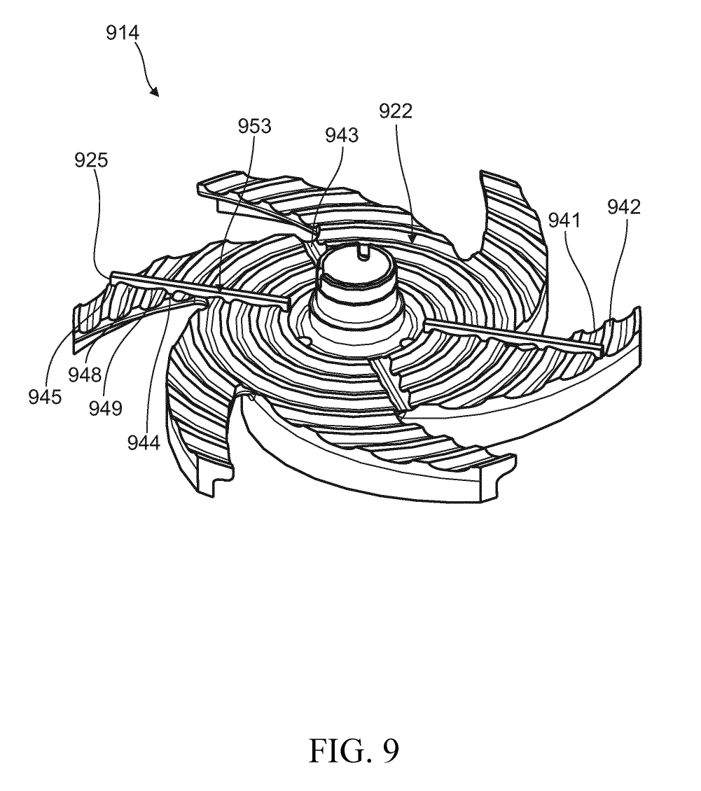

FIG. 9 shows an embodiment of the impeller 914 that combines the features of the embodiment according to FIG. 4 to FIG. 6 with the features of the embodiment according to FIG. 7. The rear side 922 of the impeller 914 in this embodiment is structured by incorporated circular peripheral grooves 941 that alternate in a concentric sequence with circular peripheral bars 942. Radial grooves 943 that are designed straight interrupt the peripheral grooves 941 and the peripheral bars 942. The radial grooves 943 run straight but are angled in the radial direction. They can also be offset to the radial direction and follow a secant. The scraper 925 possesses a smooth top edge 953 as in the embodiment according to FIG. 7. On its side facing the rear side 922, at least one bottom recess 949 is provided that extends between a first position 944 and a second position 945. At the first and second positions 944 and 945, the scraper 925 is integrally bonded with the top edges of two peripheral bars 942. The peripheral grooves 941 provided between the first and second positions 944 and 945 and the bottom recess 949 create a clearance 948 between the scraper 925 and the impeller 914 that can be cleaned particularly well. The scraper 925 is formed straight and extends over a part of the radius of the impeller 914, preferably more than 50% of this radius.

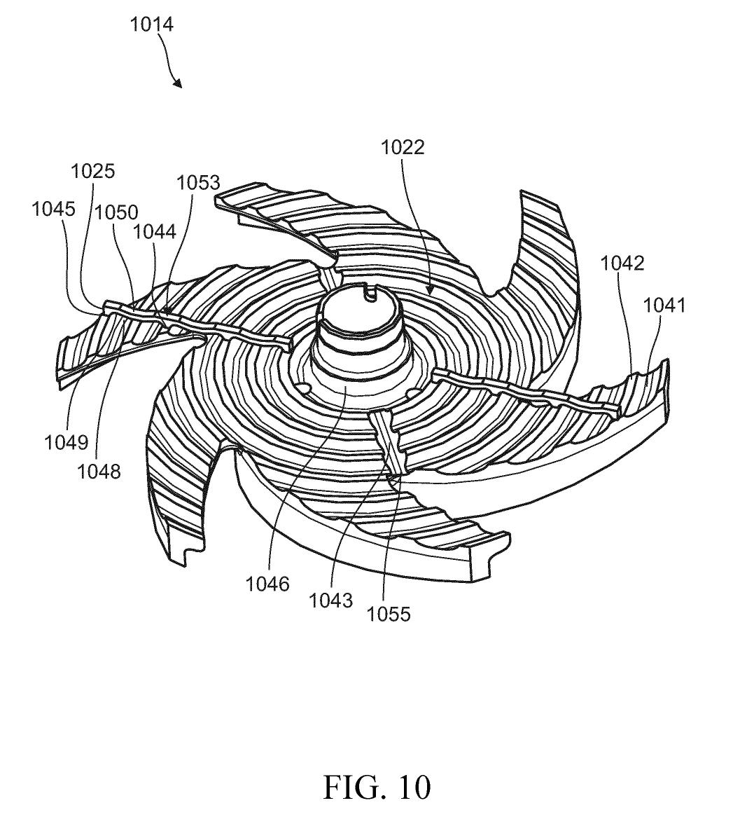

FIG. 10 shows an impeller 1014 that largely corresponds to the one in FIG. 9. In particular, the rear side 1022 has at least one peripheral groove 1041 and a peripheral bar 1042. Moreover, at least one straight radial groove 1043 can be provided that extends partially or advantageously completely between the hub 1046 and a tooth base 1055. At least one straight scraper 1025 extending in a radial direction is integrally bonded at a first location 1044 and at a second location 1045 to the rear side 1022. Between the first and second locations 1044 and 1045, the scraper 1025 has a bottom recess 1049 so that a clearance 1048 arises between the rear side 1022 and the scraper 1025. Additional bottom recesses and additional locations with an integral bond can be provided over the longitudinal extension of the scraper 1025. The clearance 1048 is enlarged by one, or more than one, peripheral groove 1041 and can therefore be cleaned better. The top edge 1053 of the scraper 1025 facing away from the rear side 1022 has at least one top recess 1050 that improves the cleaning effect of the scraper 1025.

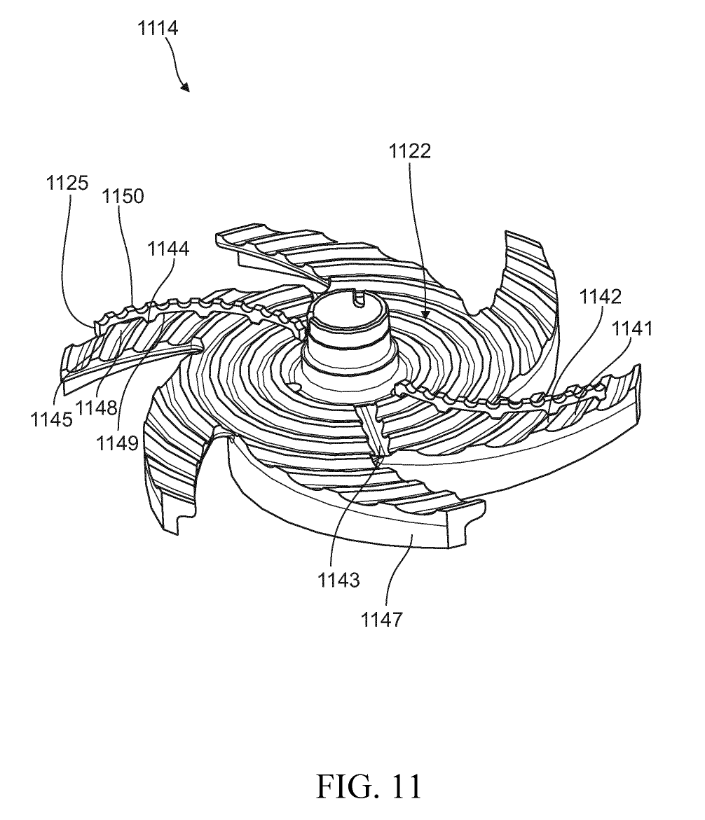

FIG. 11 shows a very economical and simultaneously highly effective embodiment of the scraper 1125 with respect to removing deposits. The scraper 1125 is produced from a perforated plate that is divided into strips, wherein each strip yields one scraper 1125. The perforated plate can be divided at the height of the holes so that a clearance 1148, bottom recesses 1149, and top recesses 1150 can easily arise. As shown in FIG. 11, the perforated plate can be bent, and its curve, following the contour of the tooth 1147, can be integrally attached to at least one first position 1144 and at least one second position 1145. A very effective function of the scraper 1125 is observed when the scraper 1125 covers at least 75% of the radius of the impeller 1114. The rear side 1122 can be designed smooth or structured, wherein the structure is more costly yet possesses a greater cleaning effect. The structure can be designed in the form of at least one peripheral groove 1141 and at least one peripheral bar 1142, and can comprise at least one radial groove 1143.

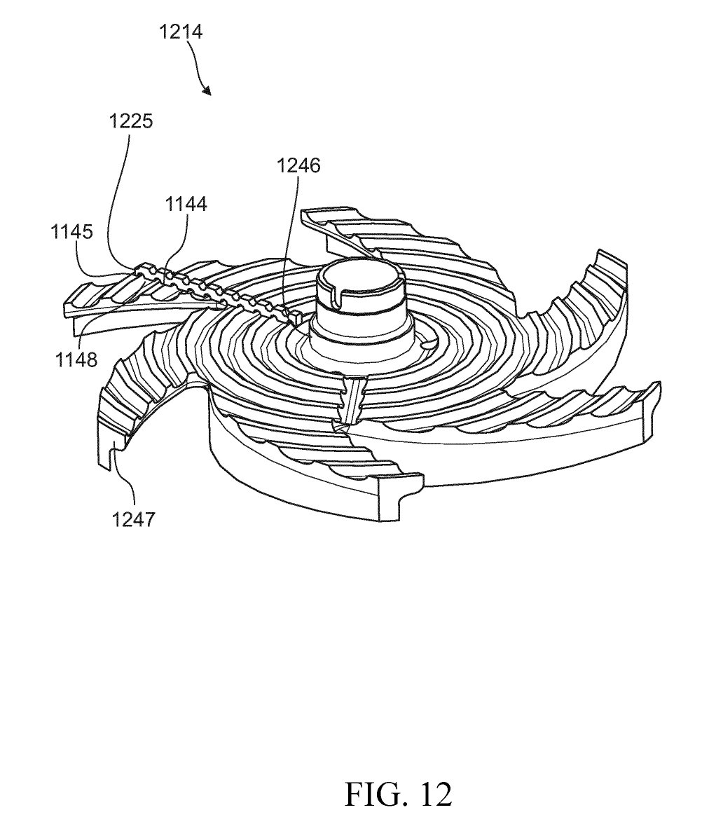

The embodiment in FIG. 12 shows an impeller 1214 with a design that differs from the impeller 1114 explained with reference to FIG. 11 in terms of the shape of the scraper 1225. The scraper 1225 is designed straight and runs from the hub 1246 up to a tooth 1247 of the impeller 1214 covering at least 75% of the impeller 1214.

The aforementioned scrapers 25, 425, 525, 625, 725, 825, 925, 1025, 1125, and 1225 are preferably designed and arranged to be balanced with respect to the rotary axis of the centrifugal pump 1 so that additional means to balance the impeller 14, 414, 514, 614, 714, 814, 914, 1014, 1114, and 1214 can be omitted.

The use of the invention has been described with reference to a centrifugal pump; however, it can also be used in a self-priming centrifugal pump. A self-priming feature can be achieved by an upstream pump stage such as a liquid ring pump stage before the inlet, and a return line. Such a return line between an intake area of a liquid ring pump stage and the part of the centrifugal pump in which pumped fluid is under pressure is described in DE 10 2007 032 228 A1, the content of which is hereby incorporated by reference.

1. An impeller for a centrifugal pump comprising a housing, an inlet, an outlet, and a chamber in the housing in fluidic contact with the inlet and the outlet, wherein the impeller is rotatably accommodated in the chamber and a gap between a rea side of the impeller and a housing wall of the housing;
a scraper integrally bonded with the impeller at a first location and a second location, wherein the first location and the second location are spaced apart from each other; and
a cleanable clearance in a space between the first location and the second location of the scraper and the rear side.

2. The impeller according to claim 1, wherein the scraper has bottom recesses on a side facing the impeller.

3. The impeller according to claim 2, wherein the rear side has a structure in the form of circular peripheral grooves and peripheral bars.

4. The impeller according to claim 1, wherein a radial extension of the scraper starts at a defined distance from a hub of the impeller.

5. The impeller according to one of the preceding claims claim 1, wherein the scraper is designed and arranged so that it is balanced relative to a rotary axis of the centrifugal pump.

6. The impeller according to claim 1, wherein a structure on the rear side of the impeller comprises at least one radial groove extending in a radial direction.

7. The impeller according to claim 1, wherein the scraper entirely covers a radius of the impeller.

8. The impeller according to claim 1, wherein the scraper has top recesses in a side facing away from the impeller.

9. The impeller according to claim 1, wherein the scraper is designed segmented and comprises at least one first segment and one second segment.

10. The impeller according to claim 1, wherein the scraper is designed bent.

11. The impeller according to claim 10, wherein a curvature of the scraper follows a contour of a tooth of the impeller.

12. A centrifugal pump comprising a housing, an inlet, an outlet and a chamber provided in the housing in fluidic contact with the inlet and the outlet, an impeller rotatably accommodated in the chamber, a gap provided between a rear side of the impeller and a housing wall of the housing, a scraper integrally bonded with the impeller at a first location and a second location, wherein the first location and the second location are spaced apart from each other, and a cleanable clearance in a space between the first location and the second location of the scraper and the rear side.

13. The centrifugal pump according to claim 12, further comprising:
a spacing element arranged between a cover and a floor and connected to the cover and the floor, wherein an axial width of the gap is at least as large as an axial thickness of the spacing element.

14. The centrifugal pump according to claim 12, wherein the scraper has bottom recesses on a side facing the impeller.

15. The centrifugal pump according to claim 12, wherein the rear side includes circular peripheral grooves and peripheral bars.

16. The centrifugal pump according to claim 12, wherein a radial extension of the scraper starts at a defined distance from a hub of the impeller.

17. The centrifugal pump according to claim 12, wherein the scraper is balanced relative to a rotary axis of the centrifugal pump.

18. The centrifugal pump according to claim 12, wherein the scraper entirely covers a radius of the impeller.

19. The centrifugal pump according to claim 12, wherein the scraper has top recesses in a side facing away from the impeller.

20. The centrifugal pump according to claim 12, wherein the scraper has a curvature that follows a contour of a tooth of the impeller.
